(19) United States
(12) Patent Application Publication
(10) Pub. No.: US 2010/0135189 A1
(43) Pub. Date: Jun. 3, 2010

(54) METHOD FOR ESTABLISHING CLOCK TRACING RELATION AND APPARATUS FOR COMPUTING CLOCK TRACING RELATION

(76) Inventors: Xinghua SHI, Shenzhen (CN); Min Zhao, Shenzhen (CN); Junjie Feng, Shenzhen (CN); Yu Wang, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/619,895

(22) Filed: Nov. 17, 2009

Related U.S. Application Data
(63) Continuation of application No. PCT/CN2008/070984, filed on May 16, 2008.

(30) Foreign Application Priority Data
May 17, 2007 (CN) 200710107043.X

(51) Int. Cl. H04L 12/28

(52) U.S. Cl. 370/254

(57) ABSTRACT

A method for establishing clock tracing relations and an apparatus for computing clock tracing relations are disclosed. The method includes: computing a Shortest Path Tree (SPT) from a clock source access node to other nodes in a network; selecting nodes governed by the clock source access node according to the SPT and the source information corresponding to the SPT; and establishing clock tracing relations from the clock source access node to the governed node consecutively along the SPT. The apparatus for computing clock tracing relations includes: a path computing unit, a source selecting unit, and a path issuing unit.

### CROSS-REFERENCE TO RELATED APPLICATIONS

This application is a continuation of International Application No. PCT/CN2008/070984, filed on May 16, 2008, which claims priority to Chinese Patent Application No. 200710107043.X, filed with the Chinese Patent Office on May 17, 2007, both of which are hereby incorporated by reference in their entireties.

### FIELD OF THE TECHNOLOGY

The present disclosure relates to communication technologies, and in particular, to a method for establishing clock tracing relations and an apparatus for computing clock tracing relations.

### TECHNICAL BACKGROUND

In a communication network, the clock is vital to the quality of network services. If the clock of a network is abnormal, service data pointer justification occurs, or even worse, the whole network breaks down.

Generally, the network uses one or more external clock sources to provide a clock reference for each node. Each network node traces an external clock source according to the tracing relation planned in a specific way, and switches the tracing relation when the network status changes. The clock tracing relation needs to fulfill one important principle: the clock tracing relation cannot be looped anytime. If the tracing relation is looped, for example, node A traces B, and B traces A, the network service deteriorates and fails shortly.

In a traditional communication network such as a traditional optical transport network, the network topology is relatively simple, namely, is mainly a chain or a ring, and the quantity of link dimensions of each node is generally 2; therefore, the tracing and switching relation is easy to plan and implement. When the clock signal on the link at one side of a node deteriorates, the clock signal on the link at the other side is traced; when the clock signals on the links at both sides are unavailable, the clock is held. Manual planning is commonly used in preventing looping of the tracing relation.

Networks are more and more complex. For example, in an Automatically Switched Optical Network (ASON) where a control plane is introduced, a network node generally has multiple dimensions, and the topological relation between nodes is complex and changes constantly. Therefore, manual planning is generally not effective in ensuring correctness of the clock tracing and switching relation of the network node.

### SUMMARY

A method for establishing a clock tracing relation and an apparatus for computing a clock tracing relation are provided in embodiments of the present disclosure to ensure correctness of the clock tracing and switching relation of a network node.

A method for establishing a clock tracing relation is provided in an embodiment of the present disclosure. The method includes:

computing a Shortest Path Tree (SPT) from a clock source access node to other nodes in a network;

selecting nodes governed by the clock source access node according to the SPT and source information corresponding to the SPT; and

establishing clock tracing relations from the clock source access node to the governed nodes consecutively along the SPT.

Another method for establishing a clock tracing relation is provided in an embodiment of the present disclosure. The method includes:

computing an SPT from a clock source access node to other nodes in a network;

selecting a node governed by the clock source access node according to the SPT and the source information corresponding to the SPT; and

delivering the SPT and the path information of the node governed by the clock source access node to the clock source access node corresponding to the governed node, where the SPT and the path information of the governed node are used for the clock source access node to establish a clock tracing relation.

An apparatus for computing a clock tracing relation is provided in an embodiment of the present disclosure. One embodiment of the apparatus includes:

a path computing unit configured to compute an SPT from a clock source access node to other nodes in a network;

a source selecting unit configured to select a node governed by the clock source access node according to the SPT and the source information corresponding to the SPT; and

a path issuing unit configured to deliver the SPT and the path information of the node governed by the clock source access node to the clock source access node corresponding to the governed node, where the SPT and the path information of the governed node are used for the clock source access node to establish a clock tracing relation.

Another embodiment of the apparatus for computing a clock tracing relation is set on a clock source access node in a network, and includes:

a path computing unit configured to compute an SPT from a clock source access node to other nodes;

a source selecting unit configured to select nodes governed by the clock source access node according to the SPT and clock source information corresponding to the SPT; and

a tracing triggering unit configured to establish a clock tracing relation from the clock source access node to the governed nodes consecutively along the SPT.

A computer-readable storage medium is provided in an embodiment of the present disclosure.

A computer-readable storage medium includes computer program codes which are executed by a clock source access node and trigger the clock source access node to perform the following steps:

computing an SPT from a clock source access node to other nodes in a network;

selecting nodes governed by the clock source access node according to the SPT and source information corresponding to the SPT; and

establishing clock tracing relations from the clock source access node to the governed nodes consecutively along the SPT.

A computer-readable storage medium includes computer program codes which are executed by a set node and trigger the set node to perform the following steps:

computing an SPT from a clock source access node to other nodes in a network;

selecting a node governed by the clock source access node according to the SPT and the source information corresponding to the SPT; and

delivering the SPT and the path information of the node governed by the clock source access node to the clock source access node corresponding to the governed node, where the SPT and the path information of the governed node are used for the clock source access node to establish a clock tracing relation.

In the embodiments of the present disclosure, the SPT from a root to other nodes is computed by using the clock source access node as the root; the node governed by each clock source access node is determined according to the SPT where the node resides; and a tracing path is established from the root to each end node consecutively. The source tracing relation of each node is governed and established by each relatively centralized clock source access node, without requiring mutual coordination between nodes. Therefore, the method is compatible with the centralized control of the network, and is extensible. The tracing relation is determined consecutively in the tree path so that the tracing relation is prevented from being looped and that the tracing path is optimized. Moreover, a computer-readable storage medium is provided. The computer-readable storage medium includes computer program codes which are executed by a clock source access node or another set node to ensure correctness of the clock tracing and switching relation of the network nodes.

### BRIEF DESCRIPTION OF THE DRAWINGS

FIG. 1 is a flowchart of a method for establishing a clock tracing relation according to a first embodiment of the present disclosure;

FIG. 2 shows a structure of an exemplary network according to the first embodiment of the present disclosure;

FIG. 3 shows an SPT of an exemplary network according to the first embodiment of the present disclosure;

FIG. 4 shows another SPT of an exemplary network according to the first embodiment of the present disclosure;

FIG. 5 shows a clock tracing relation of an exemplary network according to the first embodiment of the present disclosure;

FIG. 6 is a flowchart of a method for establishing a clock tracing relation in an ASON according to a second embodiment of the present disclosure;

FIG. 7 shows the establishing of a clock tracing relation according to the second embodiment of the present disclosure;

FIG. 8 shows a logical structure of an apparatus for computing a clock tracing relation according to a third embodiment of the present disclosure; and

FIG. 9 shows a logical structure of an apparatus for computing a clock tracing relation according to a fourth embodiment of the present disclosure.

### DETAILED DESCRIPTION OF THE EMBODIMENTS

A method for establishing a clock tracing relation according to an embodiment of the present disclosure includes: computing an SPT from a root to other nodes by using the clock source access node as the root; determining the node governed by each clock source access node according to the SPT where the node resides; and establishing a tracing path from the root to each end node consecutively. Corresponding to the method, an apparatus for computing a clock tracing relation is provided in an embodiment of the present disclosure, as detailed below.

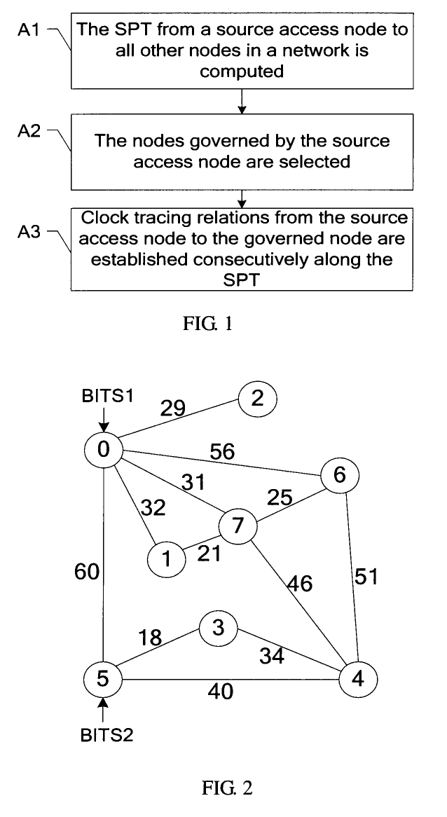

Embodiment 1: A method for establishing a clock tracing relation is provided. As shown in FIG. 1, the method includes the following steps:

A1. An SPT from a clock source access node to other nodes in a network is computed.

In this embodiment, the computation of the SPT may be a fully centralized computation. That is, the computation is undertaken by an independent network device. For example, a computation server connected to the network is responsible for computing the SPT. This independent network device responsible for computation may be regarded as a set computation node. The computation node obtains the network topology information and the clock source information to compute the SPT and select the governed node, and delivers the path information of the governed node to the corresponding clock source access node. The computation may also be partially centralized computation. That is, each clock source access node is responsible for computation. The clock source access node obtains the network topology information and the source information to compute the SPT and select the governed node. Specially, if the network has only one clock source, the computation may still be regarded as fully centralized computation.

In the process of computing the SPT, the access node of each external clock source serves as a root node, and the SPT from the root node to other nodes in the network is computed out. Therefore, the number of SPTs computed out is equal to the number of external clock sources in the network. The computation method may be a Shortest Path First (SPF) algorithm. The purpose of the algorithm is to obtain the shortest path from the clock source access node to other nodes according to a certain rule, and any algorithm that fulfills that purpose is selectable. The selection of the algorithm depends on the actual application requirements. The SPT is described below through an example.

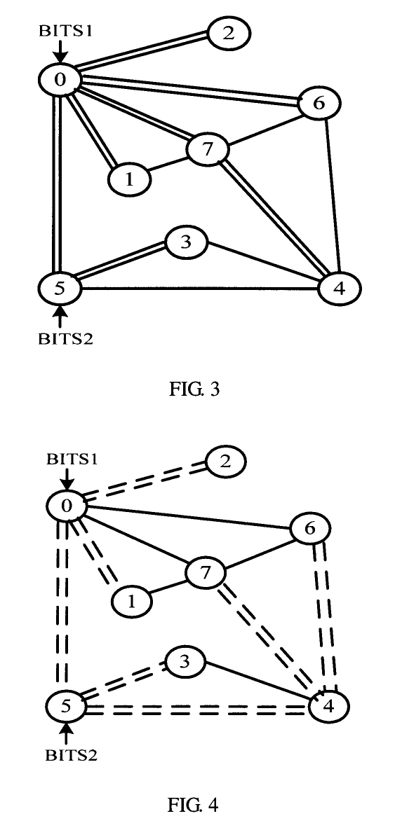

As shown in FIG. 2, it is assumed that a network includes eight nodes (nodes 0-7), and uses two Building Integrated Timing Systems (BITSs) as external clock sources, namely, BITS1 and BITS2; node 0 is the access node of BITS1, and node 5 is the access node of BITS2. The topological relation between the nodes is illustrated by the lines in FIG. 2. The numerals on the lines represent the path distance, and higher values of the numerals mean longer distances. The SPTs rooted at node 0 and node 5 are shown in FIG. 3 and FIG. 4. The double solid line in FIG. 3 denotes the SPT path of node 0, and the double dotted line in FIG. 4 denotes the SPT path of node 5. Generally, the path with fewest hops is preferred as the shortest path. If two paths have the same quantity of hops, the path with the shortest distance is preferred. The specific rules for determining the shortest path are configured according to the actual requirements.

The nodes responsible for computation (which include set computation nodes, and each clock source access node, etc., the same below) may compute the SPT by obtaining the network topology information. The network topology information may be flooded to the node responsible for computation through a routing protocol such as the Open Shortest Path First (OSPF) protocol.

A2. The nodes governed by the clock source access node are selected according to the computed SPT and the source information corresponding to the SPT.

This step determines the source to be traced by each node. When several nodes in the network trace a source, it means that the clock source access node connected to the source “governs” the nodes. The nodes governed by the clock source access node are determined in the following way:

1. If a node belongs to only one SPT, it indicates that the node can be connected to only one clock source, and therefore, it is determined that the clock source access node corresponding to the SPT governs the node;

2. If a node belongs to multiple SPTs, it indicates that the node can be connected to multiple sources, and can trace any of the sources. To optimize the tracing relation and ensure that all the clock source access nodes obtain the same governing scope result in the case of partially centralized computation, a preset selection rule may be applied to determine a clock source access node for governing the node that belongs to multiple SPTs. The following selection rules are applicable:

A. the clock source access node connected to the clock source of the highest clock quality level is selected;

B. if the clock quality level is the same, the clock source access node connected to the clock source of the highest priority is selected;

C. if both the clock quality level and the priority are the same, the clock source access node with the shortest path to the node is selected; and

D. if the clock quality level, the priority, and the path to the node are all the same, the clock source access nodes are further distinguished through some rules that lead to a unique selection result, for example, the clock source access node with the minimum serial number may be selected.

Exceptionally, if a node in the network is not in any STP computed out, it means that the node is separated and disconnected from all clock sources in the network topology. Therefore, this node is not “governed” by any clock source access node.

After the governing relation of the node is determined, the clock tracing relation of the node can be determined according to the clock source connected to the clock source access node that governs the node as well as the path of the node in the SPT corresponding to the clock source access node. If the fully centralized computation mode is applied, a set computation node needs to deliver the computed clock tracing relation to all the clock source access nodes, with a view to establishing the clock tracing relation subsequently. The computation node may deliver the clock tracing relations of the nodes throughout the network to each access node uniformly, and the access node selects the governed part. Alternatively, the computation node delivers only the part governed by each access node to each access node pertinently.

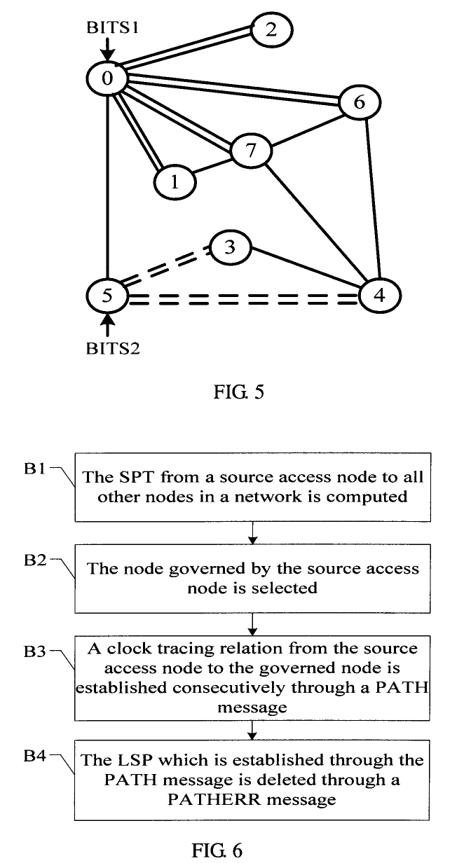

Still taking the network in FIG. 2 as an example, the determining of the clock tracing relation of the node is described below. Supposing BITS1 and BITS2 in FIG. 2 have the same quality level and priority, the clock source access node that governs each node is determined according to the shortest path of the node in the SPT. Comparison between FIG. 3 and FIG. 4 shows that: node 5 governs node 3 and node 4; node 0 governs nodes 1, 2, 6, and 7. The clock tracing relation of the node is shown in FIG. 5. In FIG. 5, the double solid line denotes the tracing path of the node governed by node 0, and the double dotted line denotes the tracing path of the node governed by node 5.

The foregoing rule for selecting the governing relation of the clock source access node shows that: in the process of determining the governing relation of the node, the node responsible for computation may need to draw upon the relevant source information, including quality level and priority information. Such information may also be flooded by the clock source access node to the whole network.

Step A1 and step A2 reveal that: regardless of fully centralized computation or partially centralized computation, both of which are based on the same information and the same computation mode and selection rule, the clock tracing relation (including the node governing relation and the corresponding tracing path) obtained by each clock source access node is consistent rather than contradictory, and requires no mutual coordination, thus fulfilling the time requirements of the clock tracing relation switching.

A3. clock tracing relations from the clock source access node to the governed nodes are established consecutively along the SPT.

The clock source access node may establish the clock tracing relation by sending signaling to the nodes governed by the clock source access node. The signaling is transmitted along the SPT path rooted at this access node. Each node establishes the clock tracing relation to the previous node consecutively, thus preventing looping of the tracing relation.

The foregoing process of establishing the clock tracing relation is performed when the system enters the normal running state after startup and initialization. The network topology information for establishing the clock tracing relation reflects the actual state of the current network, and is dynamic and real-time; and the clock source information for establishing the clock tracing relation also varies with the state of the clock source. Once such information is updated, the current clock tracing relation may be damaged or non-optimal.

Possible factors that lead to update of the network topology information include the following:

1. The link is broken or deteriorated;

2. The link recovers from break or deterioration; and

3. The clock source access node is restarted.

Possible factors that lead to update of the clock source information include the following:

1. The quality level or priority of the clock source changes;

2. The clock source is damaged or recovered; and

3. Break or recovery occurs as a result of clock source resetting.

Therefore, to ensure effectiveness of the clock tracing relation when the update of the network topology information and the clock source information is issued to the node responsible for computation, re-computation of the clock tracing relation may need to be triggered. In this case, two policies are applicable:

Policy 1: The clock tracing relation is re-computed so long as the network topology information or the clock source information is updated.

Policy 2: When the network topology information or clock source information is updated, a judgment is made about whether the updated information exerts an impact on the current clock tracing relation. If the impact is exerted, the impact retriggers computation of the SPT and selection of the node governed by the clock source access node. For example, in the clock tracing relation shown in FIG. 5, if the link between node 3 and node 4 is broken, it is judged that the tracing relation is not impacted and the re-computation needs not to be triggered; if the link between node 0 and node 7 is broken, it is judged that the tracing relation is impacted and the re-computation needs to be triggered.

Specially, to avoid frequent update caused by transient link jitters, a delay may be set against the jitters. Only the network update information that survives the delay is regarded as valid update information.

Nevertheless, re-computation of the clock tracing relation does not necessarily mean clock switching. The clock may be switched only if the re-computation result changes. In this case, it is practicable to trigger update of only the clock tracing relation of the changed part, or trigger update for all the nodes governed by a clock source access node, or trigger update for the whole network.

Taking a specific network such as ASON as an example, the following embodiment provides a method on the basis of the first embodiment.

Embodiment 2: A method for establishing a clock tracing relation in an ASON is provided. This embodiment differs from the first embodiment in that: The tracing relation is established through signaling based on the Multi-Protocol Label Switching/Generalized Multi-Protocol Label Switching (MPLS/GMPLS) protocol applied in the ASON. As shown in FIG. 6, the method includes the following steps:

B1. The SPT from a clock source access node to other nodes in a network is computed.

B2. Nodes governed by each clock source access node are selected according to the computed SPT and the clock source information corresponding to the SPT.

The foregoing two steps are similar to step A1 and step A2 in the first embodiment, and are not described further.

B3. Clock tracing relations from the clock source access node to the governed nodes are established consecutively through a PATH message. More specifically:

The clock source access node sends a PATH message carrying a specific ID hop by hop along the SPT until the message arrives at the destination node, namely, the branch end node in the governed nodes. The specific ID indicates that the sent PATH message is a special PATH message for establishing a clock tracing relation. The form of the ID is not limited in the present disclosure.

The PATH message passes through and arrives at different nodes, and such nodes determine that the message is a PATH message for establishing a clock tracing relation according to the specific ID, and trace the clock of the ingress link of the PATH message. The PATH message is transferred from the root to each end node of the SPT, and each node governed by the clock source access node establishes a tracing relation to the clock source connected to the clock source access node.

A basic fact is: all nodes on the SPT path from the clock source access node to the branch end node governed by the clock source access node are governed by the access node. Therefore, although a clock source access node may govern multiple nodes, the PATH message needs to be sent only to the governed branch end node along the SPT path, thus shortening the signaling process. The foregoing process of establishing a tracing relation is exemplified below in more detail.

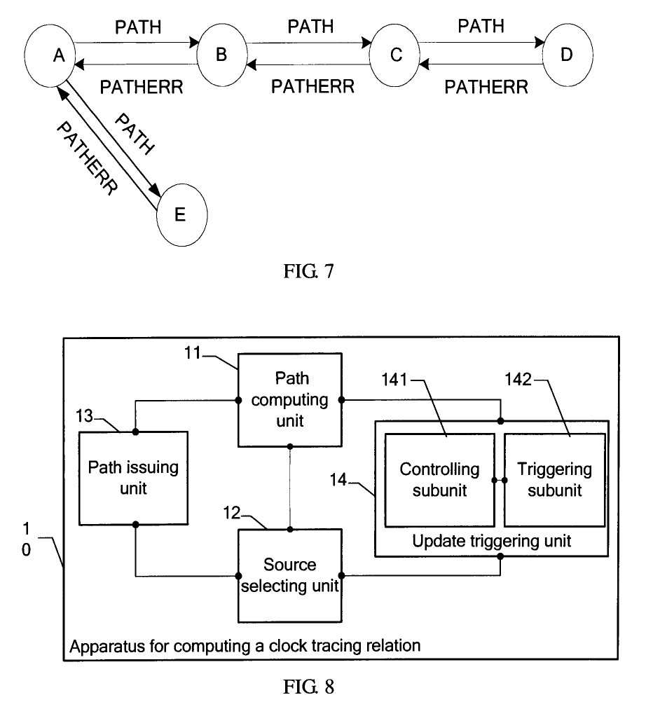

As shown in FIG. 7, it is assumed that the clock source access node A governs four nodes: B, C, D, and E, where node D and node E are branch end nodes. Therefore, the PATH signaling process of establishing a clock tracing relation initiated from node A may take either of these paths: A→B→C→D and A→E.

The foregoing process of establishing a clock tracing relation by using a PATH message is similar to a process of establishing a Label Switching Path (LSP) of a service.

For example, in FIG. 7, two clock tracing LSPs are obtained after the PATH signaling has traveled the two established paths. Such LSP information is stored in the signaling layer, thus leading to a waste of resources. Therefore, preferably, the following step is added to release resources:

B4. The LSP which is established through the PATH message is deleted through a path information deletion (PATHERR) message. More specifically:

After receiving the PATH message, the branch end node sends the PATHERR message hop by hop until the PATHERR message arrives at the destination node, namely, the clock source access node that sends the PATH message.

The PATHERR message passes through and arrives at different nodes, and such nodes delete the information about the LSP which is established through the PATH message. In FIG. 7, the arrowhead opposite to the direction of transmitting the PATH message shows the foregoing process. In this way, after the clock tracing relation is established, the signaling layer does not need to store any “clock LSP” information.

Another method for establishing a clock tracing relation is provided in an embodiment of the present disclosure. The method includes the following steps:

C1. An SPT from a clock source access node to other nodes in a network is computed.

C2. A node governed by the clock source access node is selected according to the SPT and the clock source information corresponding to the SPT.

C3. The SPT and the path information of the node governed by the clock source access node are delivered to the corresponding clock source access node, where the SPT and the path information of the governed node are used for the clock source access node to establish a clock tracing relation.

Preferably, the method further includes the following steps:

C4. After the updated network topology information and/or source information is received, a judgment is made about whether the updated network topology information and/or source information exerts an impact on the current clock tracing relation; if the impact is exerted, the process proceeds to step C5; otherwise, the process proceeds to step C6.

C5. The computation of the SPT from the clock source access node to other nodes as well as the selection of the node governed by the clock source access node is retriggered.

C6. No re-computation is triggered.

It is understandable that the software for executing the method for establishing a clock tracing relation may be stored in a computer-readable medium. When being executed, the software performs these steps: computing an SPT from a clock source access node to other nodes in a network; selecting a node governed by the clock source access node according to the SPT and the source information corresponding to the SPT; and establishing the clock tracing relation consecutively from the clock source access node to the governed node along the SPT, or delivering the computed shortest path and the path information of the node governed by the clock source access node to the corresponding clock source access node. The computer-readable medium may be a Read-Only Memory/Random Access Memory (ROM/RAM), a magnetic disk, a compact disk, and so on.

The apparatus for computing a clock tracing relation according to an embodiment of the present disclosure is detailed below.

Embodiment 3: An apparatus 10 for computing a clock tracing relation is based on the fully centralized computation mode provided in the first embodiment of the present disclosure, and is deployed on an independent computation node. As shown in FIG. 8, the apparatus includes:

a path computing unit 11 configured to compute an SPT from a clock source access node to other nodes in the network;

a source selecting unit 12 configured to select a node governed by each clock source access node according to the SPT computed out by the path computing unit 11 and the source information corresponding to the SPT; and

a path issuing unit 13 configured to deliver the SPT information obtained by the path computing unit 11 as well as the path information of the node governed by the clock source access node and obtained by the source selecting unit 12 to the clock source access node corresponding to the governed node.

To update the computed clock tracing relation according to the real-time change of the information required for computation, the apparatus 10 in this embodiment further includes an update triggering unit 14. The update triggering unit 14 is configured to retrigger the path computing unit 11 to compute the SPT and retrigger the source selecting unit 12 to select the node governed by each clock source access node. Further, the update triggering unit 14 may analyze the update information, and trigger update only when determining that update information impacts the current clock tracing relation. In this case, the update triggering unit may be:

a controlling subunit 141 configured to: judge whether the updated network topology information and/or source information exerts an impact on the current clock tracing relation after receiving the updated network topology information and/or source information; or

a triggering subunit 142 configured to retrigger the path computing unit to compute the SPT and retrigger the source selecting unit to select the node governed by the clock source access node when the judgment result of the controlling subunit 141 is positive.

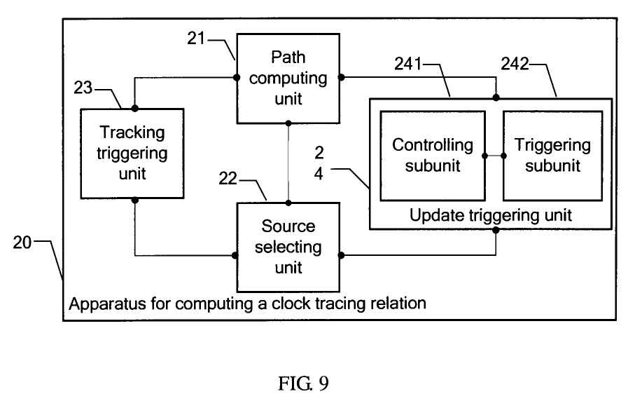

Embodiment 4: An apparatus 20 for computing a clock tracing relation is based on the partially centralized computation mode provided in the first embodiment of the present disclosure, and is deployed on each clock source access node in the network. As shown in FIG. 9, the apparatus includes:

a path computing unit 21 configured to compute an SPT from a clock source access node to other nodes;

a source selecting unit 22 configured to select nodes governed by each clock source access node according to the SPT computed out by the path computing unit 21 and the source information corresponding to the SPT; and

a tracing triggering unit 23 configured to establish clock tracing relations from the clock source access node to the governed nodes consecutively along the SPT rooted at the node of the tracing triggering unit. The tracing triggering unit 23 establishes the clock tracing relations by sending signaling to the governed nodes. For example, in an ASON, the branch end node among the governed nodes serves as a destination node, and the clock tracing relation is established by sending a PATH message that carries a specific ID. For details, the second embodiment serves as a reference.

Like the scenario in the third embodiment, to update the computed clock tracing relation according to the real-time change of the information required for computation, the apparatus 20 in this embodiment further includes an update triggering unit 24. The update triggering unit 24 may be:

a controlling subunit 241 configured to: judge whether the updated network topology information and/or source information exerts an impact on the current clock tracing relations after receiving the updated network topology information and/or source information; or

a triggering subunit 242 configured to: retrigger the path computing unit to compute the SPT and retrigger the source selecting unit to select the nodes governed by the clock source access node when the judgment result of the controlling subunit 241 is positive.

A computer-readable storage medium is provided in an embodiment of the present disclosure and includes computer program codes which are executed by a clock source access node and trigger the clock source access node to perform the following steps:

computing an SPT from a clock source access node to other nodes in a network;

selecting nodes governed by the clock source access node according to the SPT and the source information corresponding to the SPT; and

establishing clock tracing relations from the clock source access node to the governed node consecutively along the SPT.

A computer-readable storage medium is provided in an embodiment of the present disclosure and includes computer program codes which are executed by a set node and trigger the set node to perform the following steps:

computing an SPT from a clock source access node to other nodes in a network;

selecting a node governed by the clock source access node according to the SPT and the source information corresponding to the SPT; and

delivering the SPT and the path information of the node governed by the clock source access node to the clock source access node corresponding to the governed node, where the SPT and the path information of the governed node are used for the clock source access node to establish a clock tracing relation.

The details about triggering the clock source access node or the set node are the same as those in the method embodiments described above, and are not provided further.

To sum up, in the embodiments of the present disclosure, the SPT from a root to other nodes is computed by using the clock source access node as the root; each node governed by each clock source access node is determined according to the SPT where the node resides; and a tracing path is established from the root to each end node consecutively. The source tracing relation of each node is governed and established by each relatively centralized clock source access node, without requiring mutual coordination between nodes. Therefore, the method is compatible with the centralized control of the network, and is extensible. The tracing relation is determined consecutively in the tree path so that the tracing relation is prevented from being looped and that the tracing path is optimized. Besides, each clock source corresponds to an SPT and is based on certain selection rules. Therefore, multiple sources of the same quality can work simultaneously. In the method for establishing a clock tracing relation in an ASON, the tracing relation is established through signaling. Therefore, the time requirements are fulfilled in the case of switching the tracing relation; and no new reliable protocol needs to be developed and little change is made to the existing network because the signaling process itself ensures fulfillment of the transmission reliability requirements.

A method for establishing a clock tracing relation and an apparatus for computing a clock tracing relation in embodiments of the present disclosure are detailed above. Although the invention is described through some exemplary embodiments, the invention is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

What is claimed is:

1. A method for establishing clock tracing relations, comprising:
computing a Shortest Path Tree (SPT) from a clock source access node to other nodes in a network;
selecting nodes governed by the clock source access node according to the SPT and source information corresponding to the SPT; and
establishing clock tracing relations from the clock source access node to the governed nodes consecutively along the SPT.

2. The method of claim 1, wherein:
the clock source access node obtains network topology information and the clock source information to compute the SPT and select the governed nodes.

3. The method of claim 2, further comprising:
by the clock source access node, retriggering computation of the SPT and selection of the governed nodes after receiving updated network topology information and/or clock source information, and triggering establishing of a new clock tracing relation for at least a changed part when the computed or selected result changes.

4. The method of claim 1, wherein the nodes governed by the clock source access node is selected in the following way:
if a node belongs to only one SPT, the clock source access node corresponding to the SPT governs the node; or
if a node belongs to multiple SPTs, one of the clock source access nodes corresponding to the multiple SPTs is selected for governing the node according to preset rules.

5. The method of claim 4, wherein the preset rules comprise:
selecting the clock source access node connected to a source of a highest clock quality level;
if the clock quality level is the same, selecting the clock source access node connected to a source of highest priority; and
if both the clock quality level and the priority are the same, selecting the clock source access node with a shortest path to the node.

6. The method of any one of claims 1, wherein the establishing of the clock tracing relation consecutively from the clock source access node to the governed nodes comprises:
sending, by the clock source access node, a PATH message that carries a specific ID hop by hop along the SPT until the message arrives at a branch end node among the governed nodes; and
tracing, by each node which the PATH message passes through and arrives at, a clock of an ingress link of the PATH message according to the specific ID.

7. The method of claim 6, further comprising:
sending, by the branch end node after receiving the PATH message, a path information deletion message, PATHERR, hop by hop until the PATHERR message arrives at the clock source access node that sends the PATH message; and
deleting, by each node which the PATHERR message passes through and arrives at, path record information for the PATH message.

8. A method for establishing a clock tracing relation, comprising:
computing a Shortest Path Tree, SPT, from a clock source access node to other nodes in a network;
selecting a node governed by the clock source access node according to the SPT and source information corresponding to the SPT; and
delivering the SPT and path information of the node governed by the clock source access node to the clock source access node corresponding to the governed node, wherein the SPT and the path information of the governed node are used for the clock source access node to establish a clock tracing relation.

9. The method of claim 8, further comprising:
retriggering computation of the SPT and selection of the governed nodes after receiving updated network topology information and source information.

10. The method of claim 9, wherein after receiving the updated network topology information and/or source information, the method further comprises:
judging whether the updated network topology information and/or source information exerts an impact on the clock tracing relation; if the impact is exerted, retriggering the computation of the SPT and the selection of the governed nodes; otherwise, giving up triggering re-computation.

11. An apparatus for computing clock tracing relations, deployed on a clock source access node in a network, wherein the apparatus comprises:
a path computing unit configured to compute a Shortest Path Tree (SPT) from a clock source access node to other nodes;
a source selecting unit configured to select nodes governed by the clock source access node according to the SPT and clock source information corresponding to the SPT; and
a tracing triggering unit configured to establish clock tracing relations from the clock source access node to the governed nodes consecutively along the SPT.

12. The apparatus of claim 11, further comprising:
an update triggering unit configured to retrigger the path computing unit to compute the SPT and retrigger the source selecting unit to select the governed nodes after receiving updated network topology information and/or clock source information.

13. The apparatus of claim 12, wherein the update triggering unit comprises:
a controlling subunit configured to: judge whether the updated network topology information and/or clock source information exerts an impact on the clock tracing relation after receiving the updated network topology information and/or clock source information; and
a triggering subunit configured to retrigger the path computing unit to compute the SPT and retrigger the source selecting unit to select the governed nodes when a judgment result of the controlling subunit is positive.
